(19) United States
(12) Patent Application Publication
(10) Pub. No.: US 2013/0256213 A1
(43) Pub. Date: Oct. 3, 2013

(54) FILTRATION SYSTEM AND COMPONENTS THERE FOR

(71) Applicants: Ra'anan Ben-Horin, D.N. Jordan Valley (IL); Alexey Slavinsky, Kfar Hittim (IL)

(72) Inventors: Ra'anan Ben-Horin, D.N. Jordan Valley (IL); Alexey Slavinsky, Kfar Hittim (IL)

(73) Assignee: AMIAD WATER SYSTEMS LTD., D.N. Upper Galil 1 (IL)

(21) Appl. No.: 13/993,567

(22) PCT Filed: Dec. 15, 2011
(86) PCT No.: PCT/IL2011/050063

§ 371 Date: Jun. 12, 2013

Related U.S. Application Data
(60) Provisional application No. 61/423,787, filed on Dec. 16, 2010.

(51) Int. Cl. B01D 29/54; F16L 3/00; F16L 23/08; B01D 46/00

(52) U.S. Cl. CPC B01D 29/54; B01D 46/0021; F16L 3/00; F16L 23/08
USPC 210/345; 55/484; 137/561 A; 137/561 R; 248/49; 285/364

(57) ABSTRACT

A filtration array comprising a main raw fluid supply line and a main filtered fluid collecting line, at least one filtration flow path extending between the main raw fluid supply line and the main filtered fluid collecting line; each of the at least one filtration flow path is configured with a filtering assembly comprising a pair of filter units coaxially extending from a common manifold configured on the filtration flow path and is in flow communication with the main raw fluid supply line and the main filtered fluid collecting line, each of the filter units comprising a plurality of parallely disposed filter members.

### FIELD OF THE DISCLOSED SUBJECT MATTER

The present disclosed subject matter is concerned with filtration systems. The disclosed subject matter is further concerned with a fluid distribution manifold for a filtration system, as well as with filtration assemblies.

The present disclosed subject matter is also concerned with pipe couplings and a spinning member useful in filtration systems.

### BACKGROUND OF THE DISCLOSED SUBJECT MATTER

A wide variety of fluid filtering systems is available, among which are also multiple filtering systems, i.e. systems comprising a plurality of integrated filtration units.

An important consideration in the field of filtering systems is the effective filtration volume (i.e. filtration capability of a filtration system) compared with the space such a filtration system occupies, and its footprint, i.e. the effective area occupied by a filtration system.

Yet an important consideration in the field of filtering systems is the ease at which servicing and maintenance may be attended to the system.

For that purpose and others, there is a need for designing compact filtering systems as well as fluid couplings therefore.

### SUMMARY OF THE DISCLOSED SUBJECT MATTER

It is an object of the present disclosed subject matter to provide a filtration array configured with a plurality of filtration assemblies, each configured with a plurality of filter members.

According to a first aspect of the presently disclosed subject matter there is a filtration array comprising a main raw fluid supply line and a main filtered fluid collecting line, at least one filtration flow path extending between said main raw fluid supply line and main filtered fluid collecting line, each at least one filtration flow path configured with a filtering assembly comprising a pair of filter units coaxially extending from a common manifold configured on said filtration flow path and being in flow communication with the main raw fluid supply line and the main filtered fluid collecting line, each of the filter units comprising a plurality of parallely disposed filter members.

The filtration array comprises a main raw fluid supply line and a main filtered fluid collecting line, with at least one filtering assembly extending therebetween; each of said at least one filtering assembly comprising two coaxially extending filter units extending from a common manifold extending in flow communication with the main raw fluid supply line and the main filtered fluid collecting line, each of the filter units comprising a plurality of parallely disposed filter members.

An aspect of the disclosed subject matter is also concerned with a filtering assembly for mounting between a main raw fluid supply line and a main filtered fluid collecting line; said filtering assembly comprising two filter units coaxially extending from a common manifold configured for being in flow communication with the main raw fluid supply line and the main filtered fluid collecting line, each of the filter units comprising a plurality of parallely disposed filter members.

According to the presently disclosed subject matter there is disclosed a filtration array comprising a main raw fluid supply line and a main filtered fluid collecting line extending substantially parallel to one another and defining a substantially vertical plain; at least one filtering assembly extending therebetween along a filtering flow path and each comprising a pair of coaxially extending filter units coaxially extending from a common manifold configured for being in flow communication with the main raw fluid supply line and the main filtered fluid collecting line, each of the filter units comprising a plurality of parallely disposed filter members extending from a support plate dividing the manifold into an inlet chamber being in flow communication with a raw fluid main supply line, and an outlet chamber being in flow communication with a main filtered fluid collecting line; each filter member having one side of its filtrating media in flow communication with one of the inlet chamber and the outlet chamber, and another side of the filtrating media being in flow communication with the other of the inlet chamber and the outlet chamber.

Any one or more of the following configurations, features and designs can be incorporated in a filtration array according to the disclosed subject matter, independently or in one or more combinations:
The filtering assembly accommodates a manifold configured with an inlet port for coupling to one of a raw fluid main supply line and a main filtered fluid collecting line, and an outlet port for coupling to the other of the raw fluid main supply line and the main filtered fluid collecting line; said inlet port extending into an inlet chamber and said outlet port extending from an outlet chamber partitioned from said inlet chamber;
The support plates are removably secured within the manifold such that the inlet chamber of the manifold is in flow communication with one side of each support plate which in turn is in flow communication with one side of the filtrating media of the filter members, and the outlet chamber of the manifold is in flow communication with another side of the support plate, which in turn is in flow communication another side of the filtrating media of the respective filter members;
Each filtering assembly comprises a pair of filter units configured as coaxial capsule-like housing shells, each filter unit accommodating a plurality of filter members disposed at a first orientation and a plurality of filter units disposed at an opposite orientation, however extending such that the longitudinal axis of all filter units are parallel to one another and intersecting a longitudinal axis of the filtration flow path. Accordingly, the two support plates extend coaxially facing one another, however at opposite senses;
The capsule-like housing shells are detachably attached to the manifold, interconnecting therebetween a support plate, whereby removing a housing shell exposes the support plate with the articulated filtering members articulated thereto. According to a particular design, the support plate with the articulated filtering members remain secured to the manifold upon removing the housing;
The support plates are articulated to one another or, according to a different example are integrated with one another;
A longitudinal axis of the manifold extends coaxial with the filtration flow path;
A longitudinal axis of the manifold extends in a plane defined by the main raw fluid supply line and the main filtered fluid collecting line and intersecting the longitudinal axis of the raw fluid supply line and of the main filtered fluid collecting line;
The main raw fluid supply line and the main filtered fluid collecting line extend substantially parallel to one another;
The main raw fluid supply line and the main filtered fluid collecting line extend substantially horizontally;
The longitudinal axis of the manifold extends substantially vertically;
The filtration array comprises two or more filtering assemblies, said filtering assemblies disposed substantially parallel to one another;
A longitudinal axis of the filter units intersects a longitudinal axis of the filtering flow path, at a right angle or otherwise inclined;
The longitudinal axes of the filtration flow paths of the filtration array are substantially parallel to one another;
The longitudinal axes of the manifolds of the filtration array are substantially parallel to one another;
The filtering assemblies of the filtering array are disposed such that a longitudinal axis of the filter units extends perpendicular to the plain defined by and extending between the main raw fluid supply line and the main filtered fluid collecting line;
The distance between two neighboring filtering assemblies is less than the axial length of a filter unit;
The filtration flow path is configured with at least one coupling to a drain line, extending between the main raw fluid supply line and the manifold of said filtration flow path;
The filtration flow path is configured with a faucet extending before and/or after the manifold of said filtration flow path;
A filtration unit can be removed from a filtering assembly and replaced by a cover plate, such that a remaining filter unit remains functionally operative.

A further aspect of the disclosed subject matter is concerned with a support plate for a filtering unit as disclosed hereinabove. A support plate according to the present disclosure comprises a plate-like portion configured for sealing mounting within a manifold of a filter unit; said plate-like portion configured with a plurality of filter member openings each configured with a filter member coupling.

The plate-like portion has a filtration face configured for supporting the filter members.

The support plate is configured with at least one opening configured for sealing coupling to one of an inlet chamber and an outlet chamber of a manifold of the filter unit, with the filter member openings opening into the other of the inlet chamber and an outlet chamber of a manifold.

According to one particular example the filter members are articulated to the support plate by screw coupling or by a bayonet coupling, however in a substantially sealed fashion. The filter member coupling can be configured as an internal threading within the openings.

The two support plates within a filtering assembly are identical and disposed at a mirror like orientation.

The support plate is configured for articulation to a like support plate of a filtering assembly, whereby the support plates with the articulated filtering members remain secured to the manifold upon removal of the housing. According to one example a support plate is configured with one or more support posts axially extending and configured for articulating to support posts of a mating support plate, e.g. by screw coupling.

A perimeter of the plate-like portion is configured for supporting one or more sealing gaskets.

Another aspect of the present disclosure is concerned with a manifold of the filtering assemblies. The manifold comprises a housing configured for coupling a pair of filter units to a flow line extending between a main raw fluid supply line and a main filtered fluid collecting line, said housing comprising an inlet port configured for coupling to the main raw fluid supply line and extending to an inlet chamber, and an outlet port configured for coupling to the main filtered fluid collecting line and extending to an outlet chamber sealed from said inlet chamber; a support plate seat configured at least at one face of the housing and a coupling arrangement for sealingly articulating a filter unit housing to the manifold.

Any one or more of the following configurations, features and designs can be incorporated in a manifold according to the disclosed subject matter, independently or in one or more combinations:
The inlet port and the outlet port extend substantially coaxially;
A longitudinal axis of the filter unit couplers extends substantially normal to the longitudinal axis of the manifold;
The manifold is made as a unitary injection molded article;
The main inlet port and the main outlet port are configured for direct or indirect coupling to the main raw fluid supply line and the main filtered fluid collecting line, respectively;
A longitudinal axis of the filter unit couplers extends substantially normal to the longitudinal axis of the manifold;
The inlet chamber extends substantially normal to an axis extending between the inlet port and the outlet port;

Yet another aspect of the present disclosed subject matter is directed to coupling arrangements between any two axial flow segments of neighboring components.

The coupler comprises two semi circular halves with abutting surfaces at each end of the semi circle, said abutting surfaces extending substantially parallel to one another, a coupling arrangement disposed at said abutting surfaces configured for tightening the semi circular halves to one another, wherein each semi circle half is configured with a top shoulder and a bottom shoulder, each configured with an inner conical wall surface.

The inner conical wall surfaces correspond with a wall surface of a flanged portion of the two flow segments.

The coupling arrangement is one or more screw fastener or a fast release mechanism, or a toggle lock, etc.

The coupler is made of molded material, e.g. polymeric material.

A sealing gasket can be provided between mating faces of the two flow segments. A sealing gasket can be a hydraulic gasket, wherein a gasket receiving grove is configured at one or both the coupler and the two flow segments.

According to a particular example there is provided a valve-integrated coupler element integrated with a valve and an actuator, wherein the coupler comprises two semi circular halves with abutting surfaces at each end of the semi circular halves, said abutting surfaces extending substantially parallel to one another, a coupling arrangement disposed at said abutting surfaces configured for tightening the semi circular halves to one another, wherein each semi circle half is configured with a top shoulder and a bottom shoulder, each configured with an inner conical wall surface, and wherein an aperture resides between the semi circular halves configured for receiving an axle of an actuator radially projecting therebetween, said actuator extending between a valve gate within the coupler and an external actuator.

According to yet an example of a coupler according to the disclosed subject matter there is provided a flange coupler comprising a first circular retention ring and a second circular retention ring, each of which configured for clamping together, said circular retention rings configured for bearing against radially outwards projecting shoulders of the two flow segments.

Sealing coupling between the two flow segments can take place in a face-to-face contact sealing or by a sealing gasket disposed at the connection between the facing head surface of the flanged ends of the two flow segments

The first retention ring and the second retention ring are configured for clamping together by screws and bolts.

Also disclosed by the present disclosure there is a fluid spinning element configured for use in fluid flow systems. The fluid spinning element has a ring-like shape comprising cylindrical tube section, a flanged retention element and a plurality of radially extending angled vanes, extending from an inner wall of cylindrical tube section and meeting at a central vane hub.

The flanged retention element is configured for clamp-positioning between two tubular pipe segments of a hydraulic system.

The flanged retention element can be reinforced by a plurality of ribs or by a circumferentially disposed reinforcing rim at a bottom thereof.

Furthermore, a hydraulic spinning member may be disposed within the pipe work of a filtration assembly according to the disclosed subject matter.

It is appreciated that the filter unit in the following examples may be any type of filtering media such as a stack of filtering disks, a filtering screen (i.e. a fine mash of material) or a thread-type cylinder.

Also, Fluid is defined as any flowable matter, i.e. gas or liquid, regardless its purpose, degree of contamination, particle size, viscosity, pressure or any other parameters. Hence, herein in the specification and claims the term fluid is used in its broadest sense.

Raw fluid denotes a fluid (gas or liquid) to be filtered, and Rinsing fluid denotes a fluid (gas or liquid) used for rinsing/flushing the filter unit or filtering media or other components of the filter assembly. It is noted that in some cases filtered fluid serves as a rinsing fluid. Filtered fluid denotes the fluid/liquid obtained after a filtration process, namely after removing particles and contaminating matter.

Respective inlet ports and outlet ports may serve for more than one function. For example, a certain port may function at one stage as a raw fluid inlet port and at another stage may function as a waste/rinsing outlet port.

### BRIEF DESCRIPTION OF THE DRAWINGS

In order to understand the different aspects of the disclosed subject matter, and to see how it may be carried out in practice, embodiments will now be described, by way of non-limiting examples only, with reference to the accompanying drawings, in which:

FIG. 1 is a perspective view of a filtration array in accordance with the present disclosed subject matter;

FIG. 2 is a front view of the filtration array of FIG. 1;

FIG. 3 is a top view of the filtration array of FIG. 1;

FIG. 4A is a side view of the filtration array of FIG. 1;

FIG. 4B is a section along line IV-IV in FIG. 2;

FIG. 5A is an enlarged sectioned view of the filtration unit seen in FIG. 4B;

FIG. 5B is an isometric view of FIG. 5A;

FIG. 6 is a perspective view of a support plate used in a filtration array of FIG. 1;

FIG. 7 is a perspective view of a manifold used in a filter unit array of FIG. 1;

FIGS. 8A to 8G are directed to coupling arrangements between two axial tubular flow segments, in accordance with another aspect of the present disclosed subject matter, wherein:

FIGS. 8A and 8B are directed to a first type coupler;

FIG. 8C is directed to a coupler according to the example of FIGS. 8A and 8B, however fitted with a hydraulic gasket;

FIGS. 8D and 8E are directed to another valve-integrated coupler;

FIGS. 8F and 8G are directed to yet another type of a coupler;

FIG. 9A is a perspective view of a hydraulic spinning member;

FIG. 9B is a planar view of spinning member of FIG. 9A; and

FIG. 9C is a sectioned view of a coupling between two flow segments accommodating a spinning member.

### DETAILED DESCRIPTION OF SPECIFIC EXAMPLES

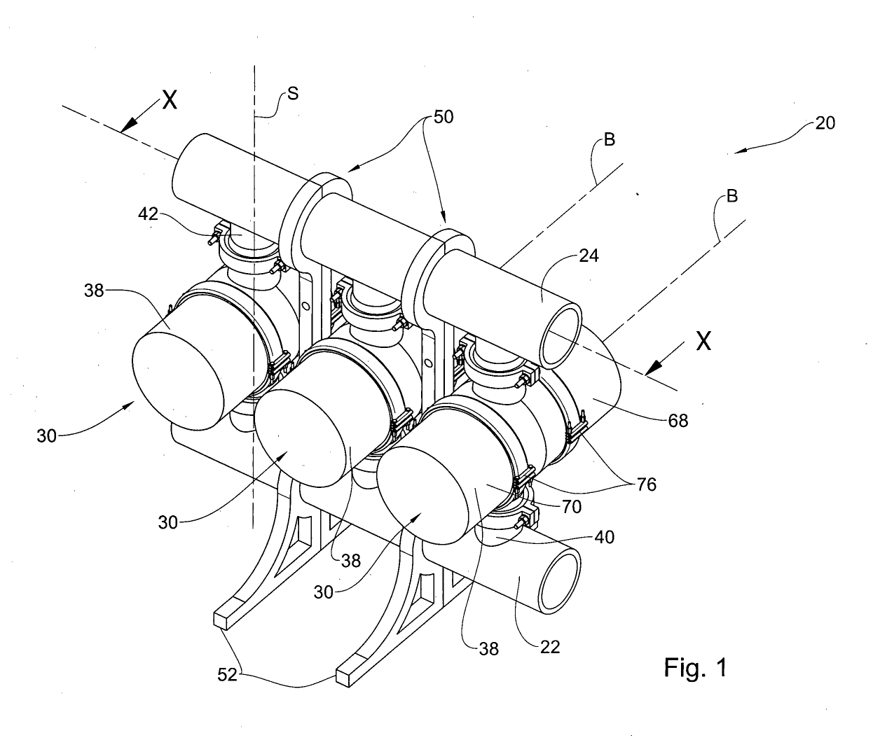

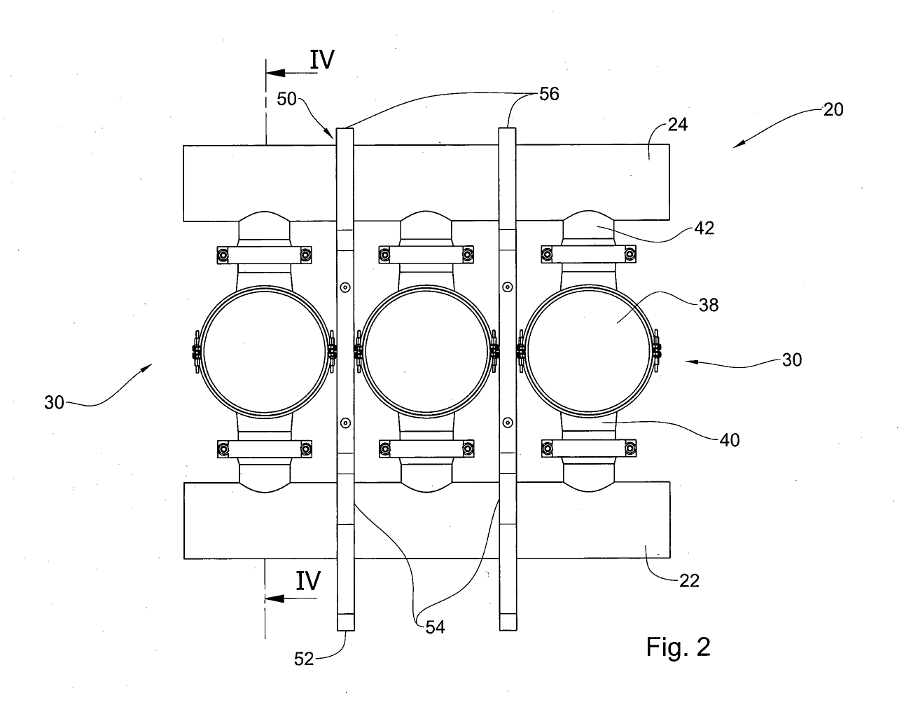

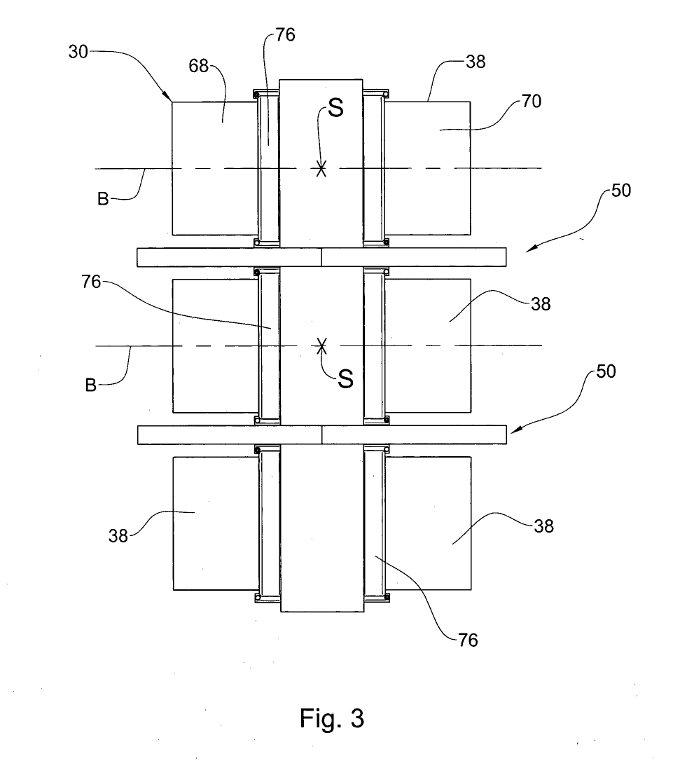

Turning first to FIGS. 1 through 5B there is illustrated a filtration array 20 in accordance with an aspect of the present disclosed subject matter. The filtration array 20 comprises a main raw fluid supply line 22 and a main filtered fluid collecting line 24 extending substantially parallel to one another and defining together a plain extended substantially vertical from the ground. However, in accordance with other configurations (not shown) the main raw fluid supply line and the main filtered fluid collecting line may extend at different configurations, with appropriate connector/coupling elements extending therebetween.

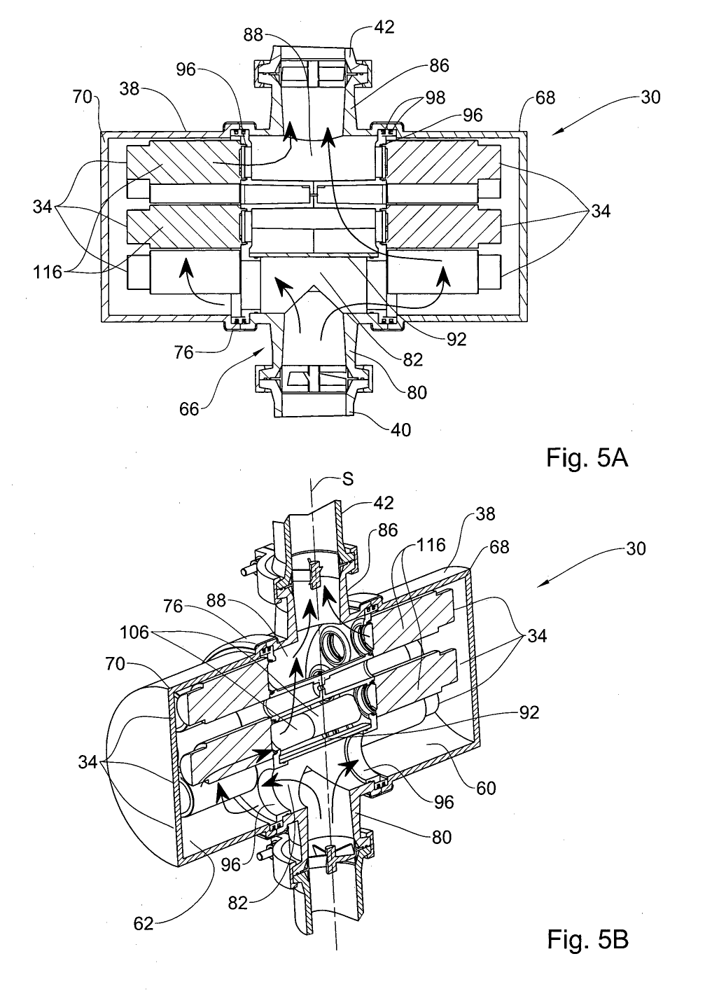

As illustrated in the drawings, the filtration array 20 comprises a plurality of filtering assemblies 30 (three illustrated in the present example) parallely extending between said main raw fluid supply line 22 and said main filtered fluid collecting line 24, wherein each of said filtering assemblies 30 comprises a puerility of parallely extending filter units 34 (FIGS. 5A and 5B) disposed within a capsule-like housing 38. As seen in the drawings, the housing 38 extends such that their longitude axis B extends substantially parallel to one another and perpendicular to the longitude axis X of the main lines 22 and 24, respectively. The filtering assemblies 30 can be disposed such that their longitudinal axis B intersects the plane defined between the main raw fluid supply line 22 and the main filtered fluid collecting line 24 at a right angle (as illustrated) or at an angle (not shown).

It is appreciated that the filter units in the following disclosure can be of any type of filtering media such as a stack of filtering disks, a filtering screen (i.e. a fine mash of material) or a thread-type cylinder, etc.

Each of the filtering assemblies 30 is coupled to the main raw fluid supply line 22 via an inter-connecting inlet pipe 40 and to the filtered fluid collecting line 24 via an interconnecting outlet pipe 42, said inter-connecting inlet pipe 40 and interconnecting outlet pipe 42 extending substantially coaxial and at an upright orientation (substantially vertical), intersecting the main raw fluid supply line 22 and the filtered fluid collecting line 24 at a right angle.

The filtration array 20 is maintained in its configuration and supported by a plurality of supports 50 configured for retaining the system in a sturdy and fixed orientation and for that purpose several supports are disposed along the length of a filtration array.

The supports 50 comprise a widened based ground engaging portion 52 for resting or supporting to a ground surface, a supply line support portion 54 and a collecting line support portion 56 extending substantially parallel to one another and substantially vertical from the ground.

Each of the supports 50 is configured of a symmetric member 56A and 56B secured to one another and thus bracing the main raw fluid supply line 22 and a main filtered fluid collecting line 24.

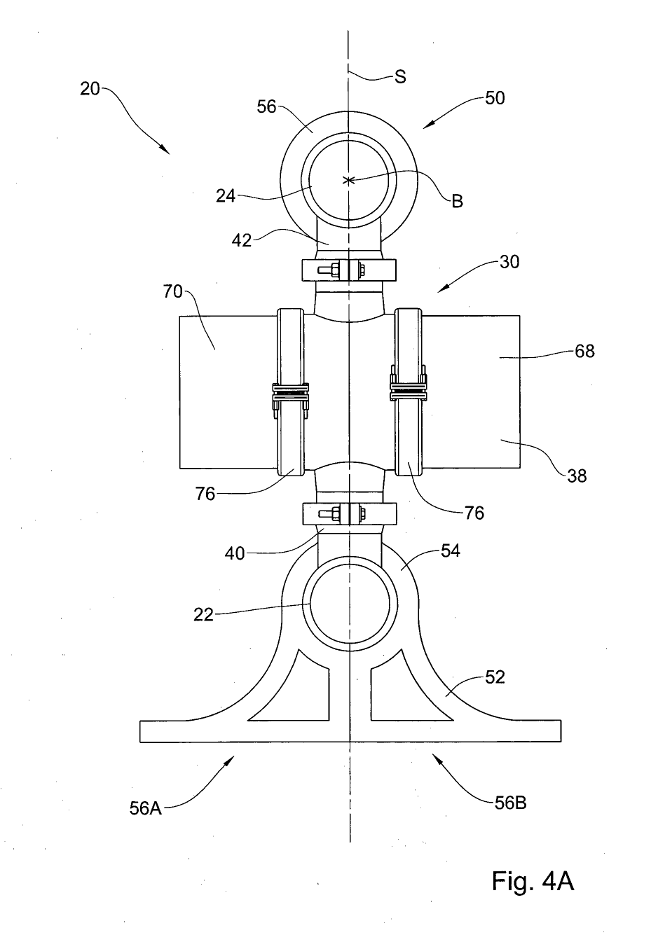

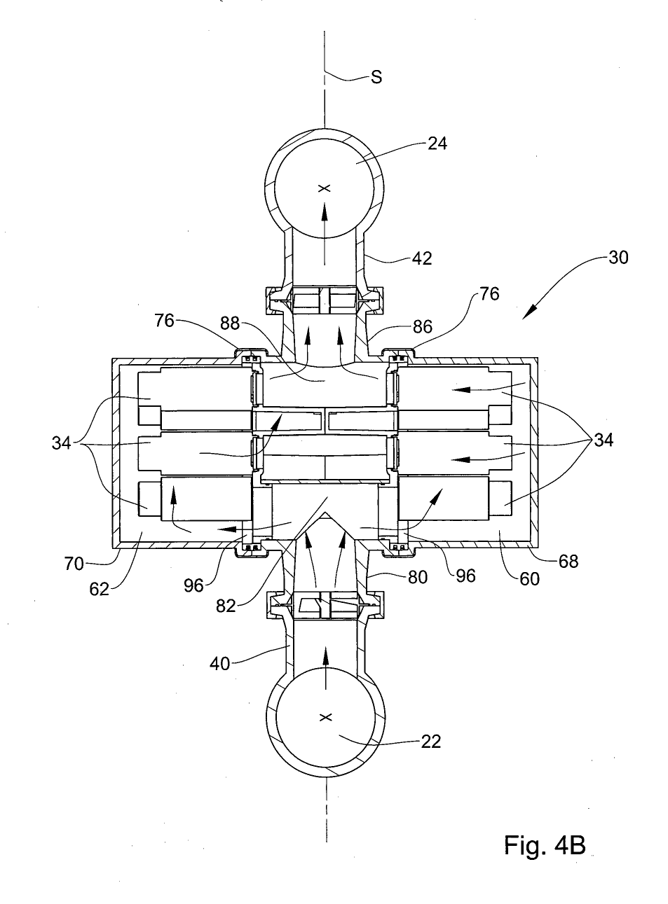

Further reference is now being made also to FIGS. 4 to 7. It is noted that the capsule-like housing 38 is divided into a right chamber 60 and left chamber 62 being a mirror image of one another. The housing 38 comprises a right shell 68 and a left shell 70 secured to central manifold 66 (FIG. 7) said coupling facilitated according to one particular example via a retention coupler ring 76 though other coupling arrangements can used as well such as, for example, screw threading, screw couplers, and the like.

The manifold 66 comprises an inlet port 80 extending from the inter-connecting inlet pipe 40 and extending into an inlet chamber 82, and further, the manifold 66 comprises an outlet port 86 configured for coupling to the inter-connecting outlet pipe 42 and extending from an outlet chamber 88 of the manifold 66, said inlet chamber 82 and outlet chamber 88 being partitioned from one another by a partition wall 92.

In the particular example it is seen that the inlet port 80 of the manifold 66, and the outlet port 86, extend upon a common longitudinal axis designated T (FIG. 7) coaxially extending with a longitudinal axis S of each of the filtering assemblies 30.

Each side of the manifold 66 is fitted with a filter coupler plate 96 (FIG. 6), securely retaining the manifold 66 in a sealing fashion, by means of a sealing gaskets receded in grooves 98 and compacted together by the bands 76. Each of the plates 96 is configured with a plurality of filter units retaining apertures 102 for screw coupling thereto, a filter unit 34 in a sealed fashion, and further, said plates 96 are configured with supports 106 facing one another and are thus configured with screw couplings apertures 108 for retention to a like coupler plate 96 in a face-to-face orientation, at a tight fashion (FIGS. 5A and 5B).

According to a modification of the disclosed example, plates 96 are integral or integrated with the manifold 66. Such a configuration makes sealing arrangements with the manifold 66 and screw coupling arrangements, redundant.

The arrangement is such that fluid flowing through the inlet port 80 flows into respective chambers 60 and 62 via opening 112 formed in the plate 96 wherein raw fluid flows through the units 34 and upon filtration through the filtration units 34 flows into the central cavity 116 of each of the filter units 34 and from there it expands into the outlet chamber 88 of the manifold 66 and then through the outlet port 86, through inter-connecting outlet pipe 42 to be discharged through the main filtered collecting line 24.

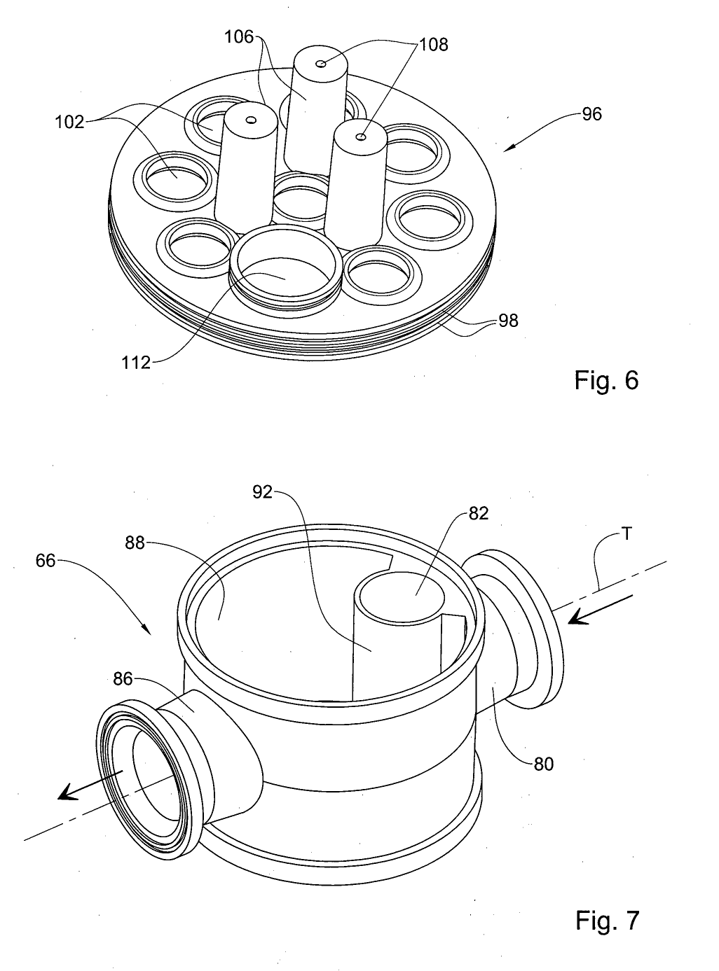

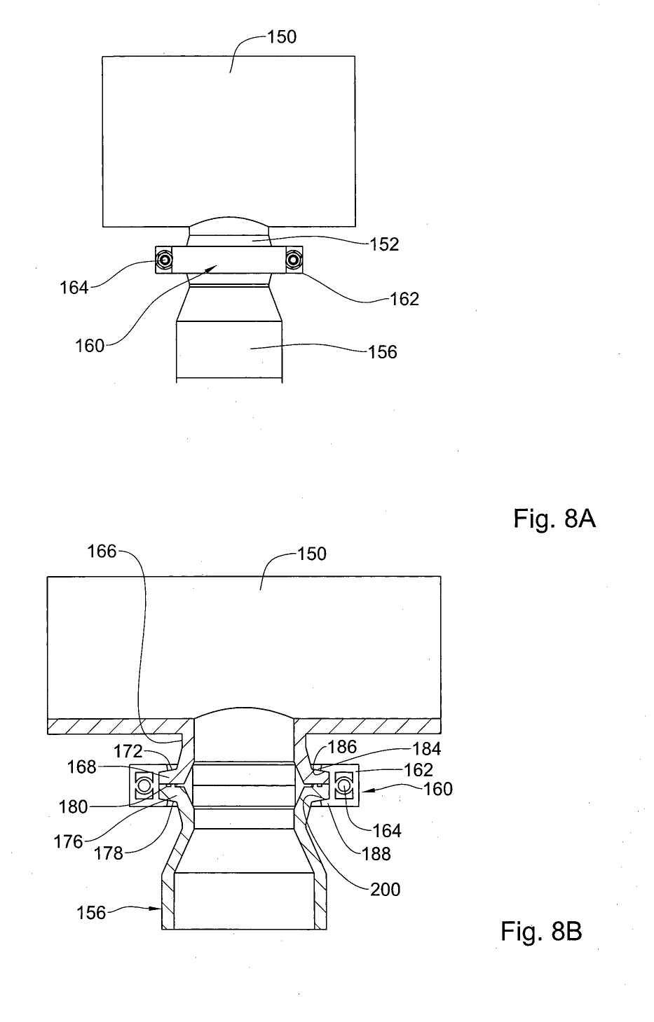

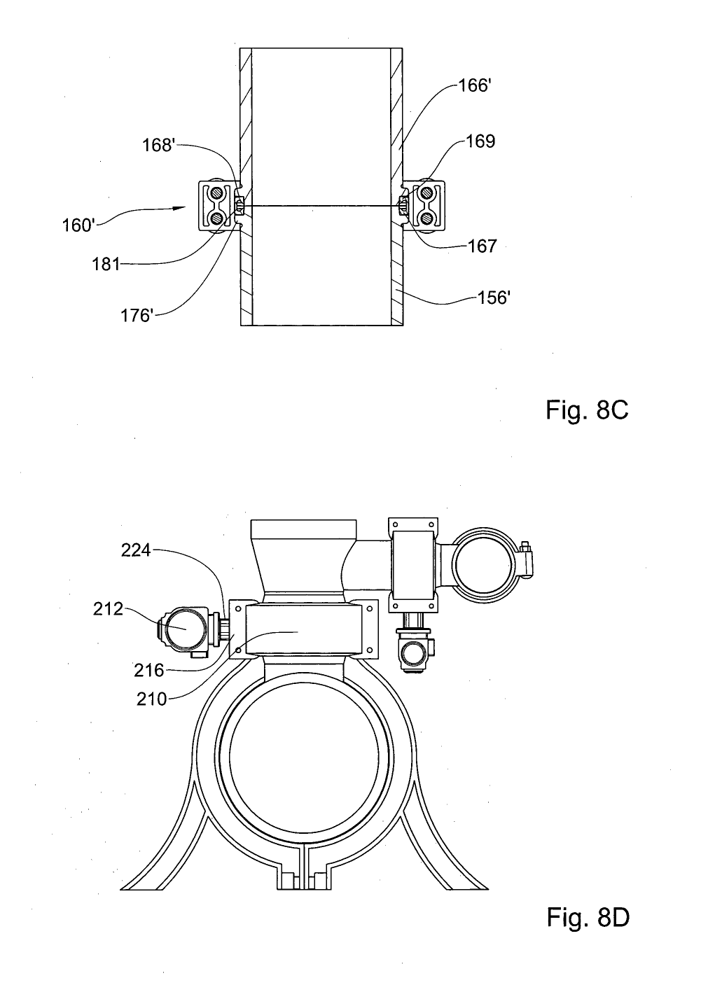

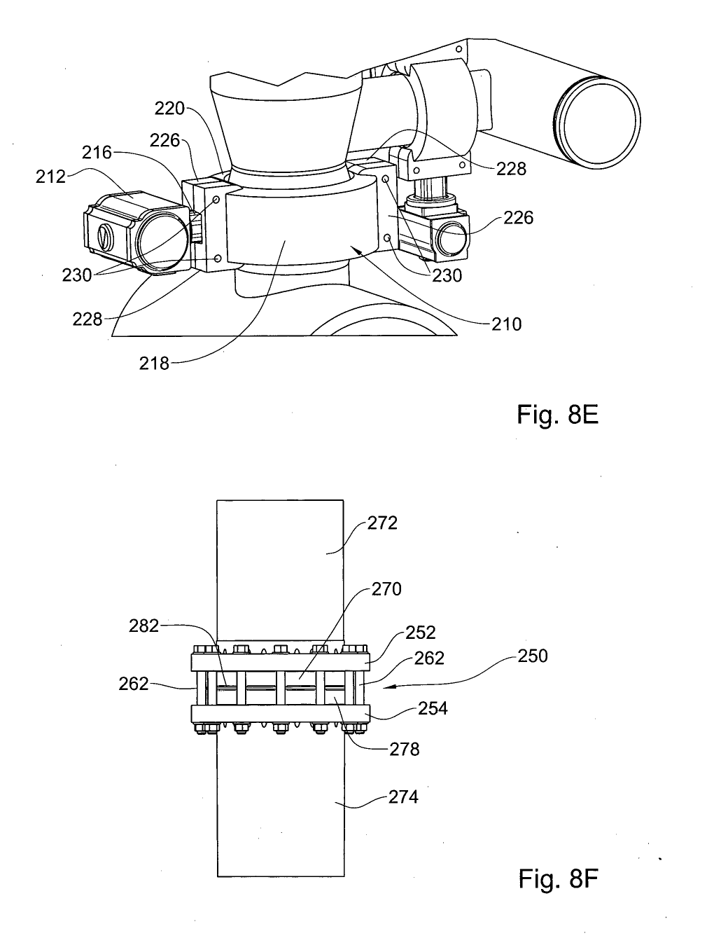

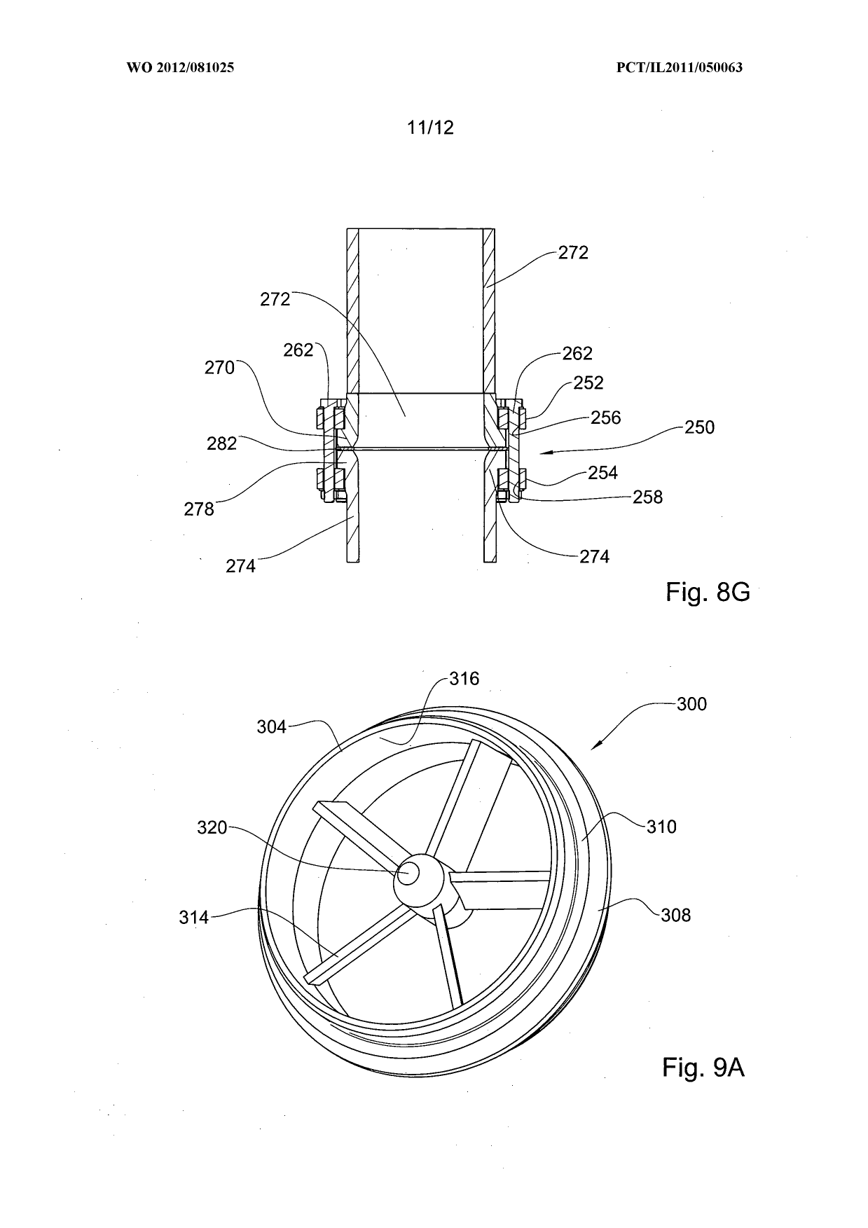

Turning now to FIGS. 8A through 8G there are illustrated different coupling systems for coupling pipe members. It should be appreciated that the disclosed subject matter is not restricted to particular fluid systems or pipe systems, but rather is provided for exemplifying.

FIG. 8A shows a header pipe 150 and a branch pipe 152 formed at 90 degrees angle with the header pipe 150. The branch pipe 152 is fastened to a secondary pipe 156 by a coupler 160, said coupler made for example of plastic material, though it can just as well be manufactured of other suitable material, e.g. metal.

The coupler 160 comprises two semi circular halves with abutting surfaces 162 at each end of the semi circle, said abutting surfaces extending substantially parallel to one another, and apertures 164 configured within the surfaces 162, to allow for insertion of bolts within the apertures 164 in order to fasten the halves together at their abutting surfaces 162.

FIG. 8B shows a longitudinal section of the coupling system of FIG. 8A. Branch pipe 152 comprises a neck portion 166 and is configured with a flanged end 168 with a conical/tapering shaped outer wall surface 172. Similarly, secondary pipe 156 is configured with a flanged end 176 with outer conical/tapering wall surface 178 and additionally at the face of flange 176 there is an annular groove 180 for receiving a sealing gasket (o-ring, not shown).

Plastic coupler 160 further comprises upper shoulder 184 with inner conical wall surface 186 which matches the form of outer wall surface 172, and a lower shoulder 188 with inner conical wall surface 200, which matches the form of outer wall 178. When the two halves of plastic coupler 160 are mounted at the junction between the branch pipe 152 and secondary pipe 156, inner conical wall surfaces 186 and 200 engage outer wall surfaces 172 and outer wall 178 respectively, and the halves are compressed by tightening of the bolts, and thus the flange 176 and flanged end 168 are pressed together and the two pipes are sealingly yet detachably joined at the junction.

The annular groove 180 (formed at one or both of the flanged ends), is configured for receiving a sealing gasket.

FIG. 8C shows a hydraulic coupler 160′ similar to the configuration illustrated in connection with FIGS. 8A and 8B, however fitted with a hydraulic gasket 181 replacing an O-ring received in the previous example. For the provision of a hydraulic gasket 181, the flanged ends 176′ and 168′ of the tubular elements 156′ and 166′, respectively, are configured with a facing annular groove 167 and 169, respectively, which together give rise a seat for the hydraulic gasket 181.

FIG. 8D and FIG. 8E show a valve-integrated coupler 210 of the coupler type described in connection with FIGS. 8A and 8B for use for example in connecting an integrated valve at the pipe junction. Thus, the coupler is integrated with a valve gate (faucet; extending within the coupler and thus not seen in the drawings), an actuator arm 224 extending from the coupler and articulated to an external actuator 212. In addition to the clamping system described above, the valve receiving coupler 210 is configured such that at the junction of the two halves 218 and 220 of the valve receiving coupler 210 an aperture 216 is formed through which extends a connecting arm 224 of the actuator 212, which in turn is attached to an associated valve.

At the ends of each semi circular halves 218 and 220 of the valve receiving coupler 210 there are provided abutting surfaces 226 and 228, respectively which comprise apertures 230 for insertion of bolts used for tightening the halves of the coupler 210 in a similar fashion as described above. However, different fastening arrangements can be configured for tightening the halves of the coupler to one another, such as a threaded bore into which volts are screwed, a toggle clamp etc., however not shown.

FIGS. 8F and 8G show a flange coupler 250 mounted at the junction of two pipes 272 and 274. The flange coupler 250 comprises an upper circular retention ring 252 and a lower circular retention ring 254, each of which have an array of apertures 256 and 258, respectively, provided for clamping of the respective rings together via bolts 262. Circular ring 252 is seated on a flanged end 270 of a pipe 272 and circular ring 254 resides adjacent to flanged end 254 of pipe 274. As the bolts 262 are tightened the two pipes 272 and 274 become fastened and secured together. Additionally, a gasket 282 is introduced at the connection between the facing head surface of the flanged ends 270 and 278, providing a sealing engagement. However it is appreciated that a face to face abutting sealing can be obtained with appropriate surface quality between the matting surfaces.

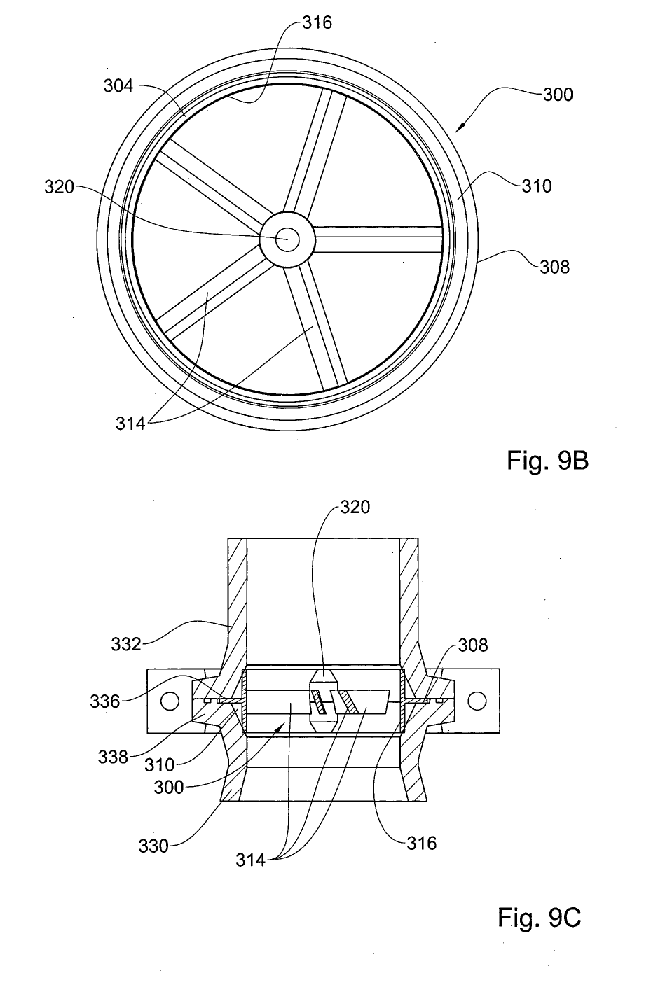

Attention is now directed to FIGS. 9A and 9B directed to a fluid spinning element 300 suitable for use in fluid flow systems. The fluid spinning element 300 has generally the shape of a ring comprising cylindrical tube section 304, a flange element 308, reinforced by support ribs or a reinforcing rim 310 circumferentially disposed about the flange element 308 for supporting it over the cylindrical tube section 304. Configured within the cylindrical tube section 304 there are a plurality of radially extending angled vanes 314 (five in the present example), radially arranged extending from an inner wall of cylindrical pipe 316 and meeting at a central vane hub 320. In the particular example the central vane hub 320 has a hydrodynamic shape so as to minimally interfere with fluid flow pattern thereabout. It is however appreciated that other hub configurations are possible too, or eliminated altogether with vanes radially coextending (not shown).

FIG. 9C shows the fluid spinning element 300 inserted at the junction of two pipe elements 330 and 332, secured together by a coupling system, e.g. such as any of the systems described above 8. Flange element 308 of the fluid spinning element 300 rests within a circumferential groove 336 configured at a flange end 338 of pipe element 330 and thus secured in place upon tightening of the coupling system. It is however appreciated that the circumferential groove cab be configured at either or both flanged end of the pipe elements 330 and 332.

It is however appreciated that additional sealing arrangements can be configured at the vicinity of the spinning element, between the two pipe segments, e.g. an O-ring, a hydraulic gasket and the like.

As fluid passes through the angled vanes 314 of the fluid spinning element 300, a spinning flow motion is created in the fluid as it leaves the fluid spinning element 300. A centrifugal force created by the spinning motion urges heavy particles residing in the fluid to gather near the walls of filter inlet pipe and thus separating the heavy particles from the main flow stream entering the filter system.

According to another example (not shown) the spinning element can be configured with straight vanes, i.e. not inclined with respect to a longitudinal flow axis, serving as a flow straightening device. According yet an example, the spinning element can be devoid of any vanes, thus serving as a gap smoothing device, between the two coupled pipe segments, thereby reducing or substantially eliminating drag forces.

It is appreciated that according to modifications of the disclosure referring to FIGS. 8A to 8C, the vanes can extend at any orientation, including parallel to the longitudinal axis (flow axis), thereby serving as flow regulators.

1. A filtration array comprising a main raw fluid supply line and a main filtered fluid collecting line, at least one filtration flow path extending between said main raw fluid supply line and main filtered fluid collecting line, each at least one filtration flow path configured with a filtering assembly comprising a pair of filter units coaxially extending from a common manifold configured on said filtration flow path and being in flow communication with the main raw fluid supply line and the main filtered fluid collecting line, each of the filter units comprising a plurality of parallely disposed filter members.

2. A filtration array comprising a main raw fluid supply line and a main filtered fluid collecting line with at least one filtering assembly disposed therebetween; each of said at least one filtering assembly comprising two coaxially extending filter units radially extending from a common manifold and extending in flow communication with a main raw fluid supply line and a main filtered fluid collecting line, each of the filter units comprising a plurality of parallely disposed filter members.

3. A filtering assembly for mounting between a main raw fluid supply line and a main filtered fluid collecting line; said filtering assembly comprising two filter units coaxially and radially extending from a common manifold configured for being in flow communication with a main raw fluid supply line and a main filtered fluid collecting line, each of the filter units comprising a plurality of parallely disposed filter members.

4. A filtration array comprising a main raw fluid supply line and a main filtered fluid collecting line extending substantially parallel to one another and defining a substantially vertical plain; at least one filtering assembly extending therebetween along a filtering flow path and each comprising a pair of coaxially extending filter units coaxially extending from a common manifold configured for being in flow communication with the main raw fluid supply line and the main filtered fluid collecting line, each of the filter units comprising a plurality of parallely disposed filter members extending from a support plate dividing the manifold into an inlet chamber being in flow communication with a raw fluid main supply line, and an outlet chamber being in flow communication with a main filtered fluid collecting line; each filter member having one side of its filtrating media in flow communication with one of the inlet chamber and the outlet chamber, and another side of the filtrating media being in flow communication with the other of the inlet chamber and the outlet chamber.

5. A filtration array according to any one of the preceding claims wherein the filtering assembly accommodates a manifold configured with an inlet port for coupling to one of a raw fluid main supply line and a main filtered fluid collecting line, and an outlet port for coupling to the other of the raw fluid main supply line and the main filtered fluid collecting line; said inlet port extending into an inlet chamber and said outlet port extending from an outlet chamber partitioned from said inlet chamber.

6. A filtration array according to any one of claims 1 to 4, wherein the support plates are removably secured within the manifold such that the inlet chamber of the manifold is in flow communication with one side of each support plate which in turn is in flow communication with one side of the filtrating media of the filter members, and the outlet chamber of the manifold is in flow communication with another side of the support plate, which in turn is in flow communication another side of the filtrating media of the respective filter members.

7. A filtration array according to any one of claims 1 to 4, wherein each filtering assembly comprises a pair of filter units configured as coaxial capsule-like housing shells, each filter unit accommodating a plurality of filter members disposed at a first orientation and a plurality of filter units disposed at an opposite orientation, however extending such that the longitudinal axis of all filter units are parallel to one another and intersecting a longitudinal axis of the filtration flow path. Accordingly, the two support plates extend coaxially facing one another, however at opposite senses.

8. A filtration array according to any one of claims 1 to 4, wherein the capsule-like housing shells are detachably attached to the manifold, interconnecting therebetween a support plate, whereby removing a housing shell exposes the support plate with the articulated filtering members articulated thereto.

9. A filtration array according to any one of claims 1 to 4, wherein a longitudinal axis of the manifold extends in a plane defined by the main raw fluid supply line and the main filtered fluid collecting line and intersecting the longitudinal axis of the raw fluid supply line and of the main filtered fluid collecting line.

10. A filtration array according to any one of claims 1 to 4, wherein the filtering assemblies of the filtering array are disposed such that a longitudinal axis of the filter units extends perpendicular to the plain defined by and extending between the main raw fluid supply line and the main filtered fluid collecting line.

11. A filtration array according to any one of claims 1 to 4, wherein the distance between two neighboring filtering assemblies is less than the axial length of a filter unit.

12. A filtration array according to any one of claims 1 to 4, wherein the filtration flow path is configured with at least one coupling to a drain line, extending between the main raw fluid supply line and the manifold of said filtration flow path.

13. A support plate for a filtering assembly, comprising a plate-like portion configured for sealing mounting to a filter manifold; said plate-like portion configured with a plurality of filter member openings each configured with a filter member coupling, and at least one opening configured for sealing coupling to one of an inlet chamber and an outlet chamber of a manifold of the filter unit, with the filter member openings opening into the other of the inlet chamber and an outlet chamber of a manifold.

14. A support plate according to claim 13, configured for articulation to a like support plate of a filtering assembly, whereby the support plates with the articulated filtering members remain secured to the manifold upon removal of the housing.

15. A support plate according to claim 13, wherein one or more support posts axially extend from a face of the plate-like portion, configured for articulating to support posts of a mating support plate.

16. A manifold for a filtering assembly, the manifold comprising a housing configured for coupling a pair of filter units to a flow line extending between a main raw fluid supply line and a main filtered fluid collecting line, said housing comprising an inlet port configured for coupling to the main raw fluid supply line and extending to an inlet chamber, and an outlet port configured for coupling to the main filtered fluid collecting line and extending to an outlet chamber sealed from said inlet chamber; a support plate seat configured at least at one face of the housing and a coupling arrangement for sealingly articulating a filter unit housing to the manifold.

17. A manifold according to claim 16, wherein the inlet port and the outlet port extend substantially coaxially.

18. A manifold according to claim 16, wherein a longitudinal axis of the filter unit couplers extends substantially normal to the longitudinal axis of the manifold.

19. A manifold according to claim 16, made as a unitary injection molded article.

20. A support plate according to claim 14, wherein the main inlet port and the main outlet port are configured for direct or indirect coupling to the main raw fluid supply line and the main filtered fluid collecting line, respectively.

21. A support plate according to claim 14, wherein a longitudinal axis of the filter unit couplers extends substantially normal to the longitudinal axis of the manifold.

22. A support plate according to claim 14, wherein the inlet chamber extends substantially normal to an axis extending between the inlet port and the outlet port.

23. A coupler for coaxially articulating two flow segments, the coupler comprising two semi circular halves with abutting surfaces at each end of the semi circle, said abutting surfaces extending substantially parallel to one another, a coupling arrangement disposed at said abutting surfaces configured for tightening the semi circular halves to one another, wherein each semi circle half is configured with a top shoulder and a bottom shoulder, each configured with an inner conical wall surface.

24. A coupler according to claim 23, wherein the inner conical wall surfaces correspond with a wall surface of a flanged portion of the two flow segments.

25. A coupler according to claim 23, wherein a sealing gasket is provided between mating faces of the two flow segments.

26. A coupler according to claim 23, wherein an aperture resides between the semi circular halves configured for receiving an axle of an actuator radially projecting therebetween.

27. A coupler according to claim 26, wherein the aperture extends about a radial axis, normal to a longitudinal axis of the coupler.

28. A coupler for coaxially articulating two flow segments, the coupler comprising a first circular retention ring and a second circular retention ring, each of which configured for clamping together, said circular retention rings configured for bearing against radially outwards projecting shoulders of the two flow segments.

29. A coupler according to claim 28, wherein the first retention ring and the second retention ring are configured for clamping together by screws and bolts.

30. A fluid spinning element having a ring-like shape comprising cylindrical tube section, a flanged retention element and a plurality of radially extending vanes, extending from an inner wall of cylindrical tube section and meeting at a central vane hub.

31. A fluid spinning element having a ring-like shape comprising cylindrical tube section, a flanged retention element and a plurality of radially extending angled vanes, extending from an inner wall of cylindrical tube section and meeting at a central vane hub.

32. A fluid spinning element according to claim 30, wherein the vanes are inclined about a longitudinal flow axis thereof.

33. A fluid spinning element according to claim 32, configured for use in fluid flow systems, wherein the flanged retention element is configured for clamp-positioning between two tubular pipe segments of a hydraulic system.

34. A fluid spinning element according to claim 30, configured with straight vanes.
